(19) United States
(12) Patent Application Publication
(10) Pub. No.: US 2008/0176021 A1
(43) Pub. Date: Jul. 24, 2008

(54) Inner lining structure for photoresistant collecting devices

(75) Inventors: Chen-Hsiang Hung, Hsin-Tien City (TW); Chih-Ming Lian, Hsin-Tien City (TW); Hsun-Min Lee, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(73) Assignee: LITE-ON SEMICONDUCTOR CORP.

(21) Appl. No.: 11/654,646

(22) Filed: Jan. 18, 2007

(51) Int. Cl. B32B 3/02

(52) U.S. Cl. 428/66.6

(57) ABSTRACT

An inner lining structure for a photoresistant collecting device includes a body, a receiving groove and a through-hole. A periphery of the body is a circular arced surface. A receiving groove is formed by concaving a top of the body downwards and the upper end is shaped like an opening. A through-hole is arranged in a center of the body and penetrates a bottom surface of the receiving groove and a bottom of the body. Based on the above assembly, the present invention engages with a sucking plate of a photoresistant coater and ensures that photoresistant filaments cannot adhere to the bottom of a wafer when the wafer is operated at a high speed.

### BACKGROUND OF THE INVENTION

1. Field of the invention

The present invention relates to an inner lining structure for photoresistant collecting devices, and more especially to an inner lining structure for photoresistant collecting devices in photoresistant coaters.

2. Description of the prior art

At present, the photoresistant coating used in a wafer is produced via a rotating photoresistant coater. The photoresistant coater drops moderate liquid photoresistant with a high viscosity on the center of the top surface of a wafer and turns the wafer at a high speed. Due to the centrifugal force created by the turning of the wafer, the photoresistant expands outwards quickly and uniformly adheres to the surface of the wafer. Excess photoresistant is meanwhile thrown off the surface of the wafer and drained away via a photoresistant collecting device mounted on the photoresistant coater. However, the excess photoresistant is easily scattered around and needs to be removed by drawing air out of the device.

The coater has a sucking plate and sucks the wafer on the sucking plate. The sucking plate connects with a turnable axis at a bottom thereof which rotate the wafer at a high speed. The photoresistant collecting device has an inner lining mounted under the sucking plate.

As shown in FIG. 1, an inner lining 10a of a prior art photoresistant collecting device has a circular base portion 11a and a projecting portion 12a protruding from a center of the base portion 11a, which forms a step-shaped surface structure. The turnable axis (not shown) of the coater extends through the base portion 11a and the projecting portion 12a and out of a top of the inner lining 10a to connect with the sucking plate 100a, thereby the sucking plate 100a is mounted over the inner lining 100a and maintains a certain distance from the inner lining 10a. The sucking plate 100a can suck a wafer (not shown) and rotate the wafer.

When the sucking plate operates at a lower rotating speed, the excess photoresistant thrown off by the wafer has a drip shape. However, when the sucking plate operates at a higher rotating speed, the photoresistant has a filament shape, such as cotton candy, and a weak vacuum is created under the sucking plate to form negative pressure. At the same time, the lighter photoresistant filaments produce a restoring force to themselves after being thrown out and breaking. As such, the photoresistant filaments easily adhere to the bottom of the wafer under the influence of the negative pressure under the sucking plate and the restoring force.

The prior art inner lining structure has shortcomings as described below:

1. The distance between the inner lining and a top surface of the sucking plate is too large, so that the photoresistant filaments are easily sprayed back on the bottom of the wafer, even if an iron ring is mounted between the inner lining and the sucking plate;

2. The step of the inner lining is too high, so that the photoresistant filaments easily remain on the bottom of the wafer under the guidance of airflow caused by suction.

Hence, the inventors of the present invention believe that the shortcomings described above are able to be improved upon and suggest the present invention which is of a reasonable design and is an effective improvement based on deep research and thought.

### SUMMARY OF THE INVENTION

An object of the present invention is to provide an inner lining structure for photoresistant collecting devices to ensure that excess photoresistant filaments don't remain on the bottom of a wafer when the wafer is being spun at a high speed in the process of being coated with photoresistant.

Another object of the present invention is to provide an inner lining structure for photoresistant collecting devices which adjusts the height and level of the inner lining so the present invention can be applied to different products or types of devices.

To achieve the above-mentioned object, an inner lining structure for photoresistant collecting devices in accordance with the present invention is disclosed. The inner lining structure for photoresistant collecting devices includes a body having a periphery which is a circular arced surface that gradually shrinks in size as it gets higher, a receiving groove formed by concaving the top of the body downwards, which has an upper end shaped like an opening; and a through-hole arranged in a center of the body and penetrates a bottom surface of the receiving groove and a bottom of the body.

The efficacy of the present invention is as follows: the present invention reduces the distance between the top surface of the sucking plate and the upper flange of the inner lining so that it is difficult for the photoresistant filaments to remain on the bottom of the wafer; and the present invention includes adjustable screws that can be used to adjust the height and the level of the inner lining so that the present invention can be applied to different products.

To further understand the features and technical contents of the present invention, please refer to the following detailed description and drawings related to the present invention. However, the drawings are only to be used as references and explanations, and not to limit the present invention.

### BRIEF DESCRIPTION OF THE DRAWINGS

FIG. 1 is a sketched view of a prior inner lining engaging with a sucking plate;

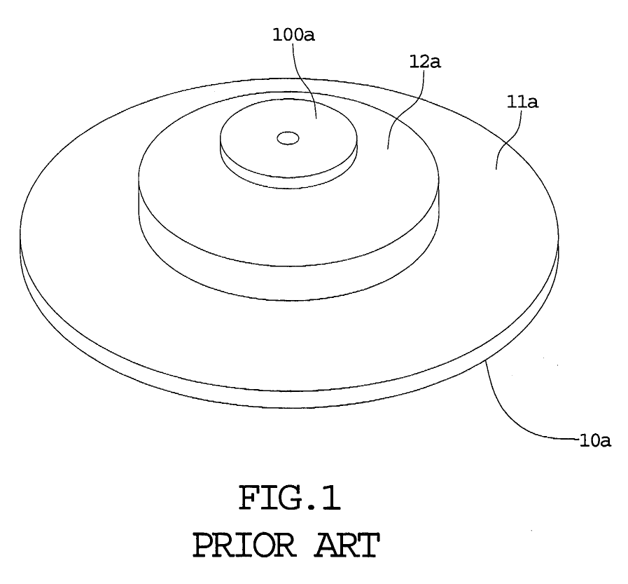

FIG. 2 is an exploded perspective view of an inner lining structure for photoresistant collecting devices in accordance with the present invention;

FIG. 3 is a sectional view of the inner lining structure for photoresistant collecting devices in accordance with the present invention;

FIG. 4 is an exploded perspective view of the inner lining structure for photoresistant collecting devices in accordance with the present invention, from another angle; and

FIG. 5 is a sectional view of the inner lining engaging with a turnable axis, a sucking plate and a wafer in accordance with the present invention.

### DETAILED DESCRIPTION OF THE INVENTION

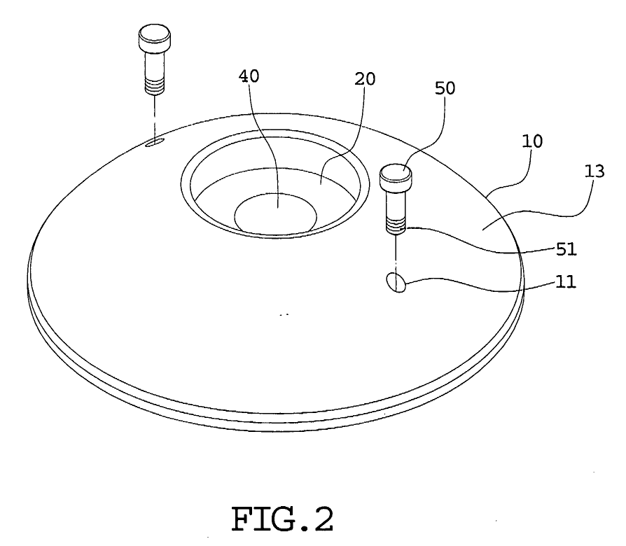

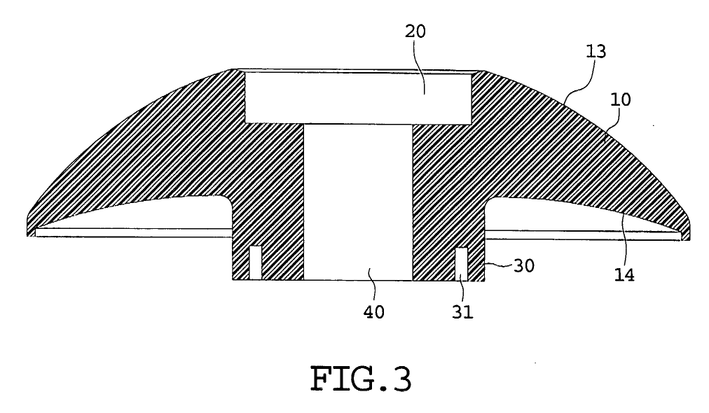

Please refer to FIGS. 2-4, in which an inner lining structure for photoresistant collecting devices in accordance with a preferred embodiment of the present invention is shown. The inner lining structure for photoresistant collecting devices includes a body 10, a receiving groove 20, a connecting pole 30, a through-hole 40, and two handles 50.

The body 10 is slightly shaped like a disc, the periphery of which is a circular arced surface 13 that gradually shrinks in size as it gets higher. The body 10 has two thread holes 11 formed in the circular arced surface 13. The two thread holes 11 are symmetrically formed at two sides of the body 11 for engaging with the two handles 50. The body 10 further has another circular arced surface 14 concaving inwards on a bottom thereof.

The receiving groove 20 is shaped like a circle and formed by concaving a top of the body 10 downwards. The receiving groove 20 is inside the body 10 and has an upper end shaped like an opening.

The connecting pole 30 is shaped like a short column and protrudes downwards from a center of the circular arced surface 14 on the bottom of the body 10. The connecting pole 30 has a cut groove 31 shaped like a ring and is formed in a bottom surface near a fringe thereof The cut groove 31 extends upwards from the bottom surface of the connecting pole 30 in the connecting pole 30 for a predetermined depth.

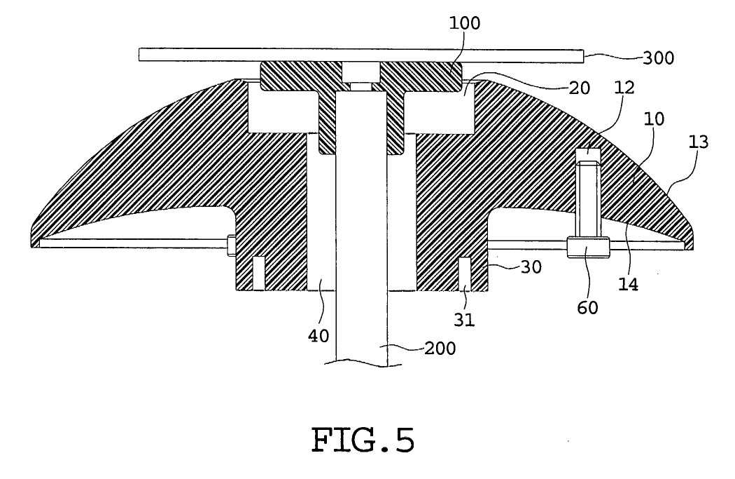

The through-hole 40 is shaped like a circle at a center inside the body 10. The through-hole 40 penetrates a bottom surface of the receiving groove 20 and the bottom surface of the connecting pole 30 for engaging with a turnable axis 200 (as show in FIG. 5) of a photoresistant coater.

The two handles 50 both have screw threads 51 on bottoms thereof and are fixed on the body 10 via the engagements of the screw threads 51 and the two thread holes 11 of the body 10, thereby the two handles 50 are protrudently mounted on the top of the body 10, which is convenient for a user to hold the body 10.

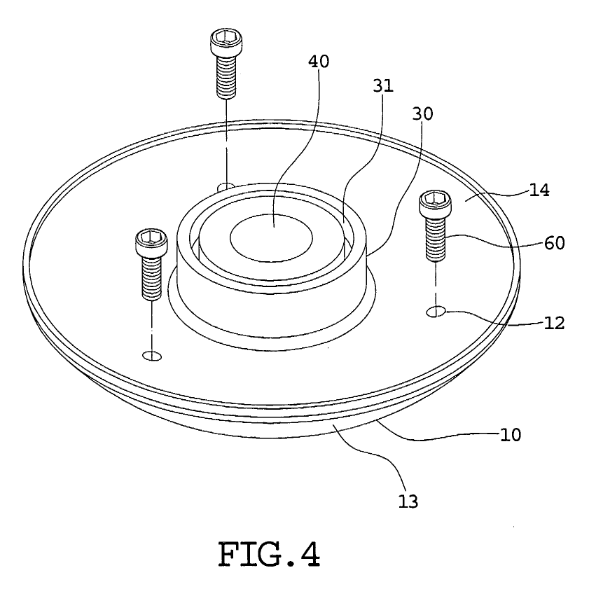

Please prefer to FIG. 4. The present invention further has three adjusting screws 60 mounted on the bottom of the body 10 to form an adjustable structure. The body 10 has three thread holes 12 arranged on the bottom thereof at intervals, corresponding to the three adjusting screws 60. Tail portions of the three adjusting screws 60 are locked in the three thread holes respectively and head portions of the three adjusting screws 60 protrude out of the bottom of the body 10 and can collide with an inner surface of a photoresistant collecting device (not shown). The present invention can adjust the height and the level of the body 10 by adjusting the height from which the three adjusting screws 60 protrude from the bottom of the body 10.

Please prefer to FIG. 5. The inner lining structure of the present invention is disposed in the photoresistant collecting device (not shown) and can engage with a turnable axis 200 of a photoresistant coater (not shown) and a sucking plate 100 mounted on a top of the turnable axis 200. The cut groove 31 of the connecting pole 30 can engage with an annular protruding rib (not shown) preformed on an inner surface of the photoresistant collecting device so that the body 10 can be mounted in the photoresistant collecting device.

The body 10 is arranged under the sucking plate 100. Because the inner diameter of the receiving groove 20 is greater than that of the sucking plate 100, the sucking plate 100 can be received in the receiving groove 20 and a top surface of the sucking plate 100 slightly protrudes from and closes to an upper flange of the body 10. A wafer 300 is placed on the top surface of the sucking plate 100. The sucking plate 100 sucks and fixes the wafer 300 on the top by means of suction in order that the wafer 300 can synchronously turn with the sucking plate 100. The turnable axis 200 extends from the bottom of the body 100 into the receiving groove 20 through the through-hole 40 and connects with a bottom of the sucking plate 100. The turnable axis 200 can rotate the sucking plate 100 for the photoresistant coating process.

During the photoresistant coating process, after being thrown off, excess photoresistant on the wafer 300 flows along an inner wall of the photoresistant collecting device into the bottom of the photoresistant collecting device. At the same time, the photoresistant collecting device draws air out and induces the photoresistant via a suction hole (not shown) in a bottom thereof to drain the photoresistant from a draining hole (not shown).

Accordingly, the present invention adopts the body with a circular arced surface structure instead of a step-shaped surface structure, reduces the outer diameter of the body 10 and increases the thickness of the body 10 (increases the height of prior iron rings), thereby the photoresis filaments easily attach themselves to the circular arced surface 13 of the body 10 under the guidance of airflow caused by suction. Furthermore, the present invention has a receiving groove 20 receiving the sucking plate 100, so that the sucking plate 100 can be embedded in the receiving groove 20 and the distance between the top surface of sucking plate 100 and the upper flange of the body 10 is reduced. Thereby, even if the wafer 300 is operating at a high speed, it is difficult for the photoresis filaments to enter the space between the sucking plate 100 and the body 10 and the photoresis filaments cannot adhere to the bottom of the wafer 300.

Additionally, three adjusting screws 60 are mounted on the bottom of the body 10 to adjust the height and the level of the inner lining structure. This ensures that the interval between the surface of the sucking plate 100 and the upper flange of the body 10 can be adjusted so that the present invention can be applied to different products.

What is disclosed above is only the preferred embodiment of the present invention and it is therefore not intended that the present invention be limited to the particular embodiments disclosed. It will be understood by those skilled in the art that various equivalent changes may be made depending on the specification and the drawings of present invention without departing from the scope of the present invention.

What is claimed is:

1. An inner lining structure for a photoresistant collecting device, comprising:
a body, having a periphery which has a circular arced surface that gradually shrinks in size as it gets higher;
a receiving groove, formed by concaving a top of the body downwards and having an upper end shaped like an opening; and
a through-hole, arranged in a center of the body and penetrating a bottom surface of the receiving groove and a bottom of the body.

2. The inner lining structure as claimed in claim 1, wherein two handles are mounted on the top of the body.

3. The inner lining structure as claimed in claim 1, wherein the body has another circular arced surface concaved inwards on a bottom thereof and at least two adjusting screws.

4. The inner lining structure as claimed in claim 1, wherein a connecting pole protrudes downwards from a center of the bottom of the body, the through-hole extends to a bottom surface of the connecting pole and the connecting pole has a cut groove that is formed in the bottom surface.

5. The inner lining structure as claimed in claim 1, wherein the receiving groove receives a sucking plate of which a top surface protrudes from an upper flange of the body and the sucking plate is mounted on a turnable axis which extends through the through-hole and connects with a bottom of the sucking plate.
